(19) United States
(12) Patent Application Publication
(10) Pub. No.: US 2008/0198283 A1
(43) Pub. Date: Aug. 21, 2008

(54) Display apparatus

(75) Inventors: Yeo-Geon Yoon, Seoul (KR); Myung-Koo Hur, Cheonan-si (KR); Sang-Ki Kwak, Cheonan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/004,742

(22) Filed: Dec. 19, 2007

(30) Foreign Application Priority Data
Feb. 21, 2007 (KR) 10-2007-0017472

(51) Int. Cl. G02F 1/1343; G09G 3/36

(52) U.S. Cl. 349/37; 349/143

(57) ABSTRACT

A display panel includes a plurality of gate lines, a plurality of data lines and a plurality of pixel groups. The gate lines extend in a first direction and sequentially receive gate signals, and the data lines extend in a second direction that is substantially perpendicular to the first direction and receive data signals. Each pixel group includes first, second and third vertical pixels that extend in the second direction and are sequentially arranged in the first direction. The first to third vertical pixels are arranged horizontally and are electrically connected to three consecutive gate lines to receive gate signals, and are connected to two or fewer data lines to receive the data signals.

### CROSS-REFERENCE TO RELATED APPLICATION

This application relies for priority upon Korean Patent Application No. 10-2007-17472 filed on Feb. 21, 2007, the contents of which are herein incorporated by reference in its entirety.

### BACKGROUND OF THE INVENTION

1. Field of the Invention

The present invention relates to a display apparatus. More particularly, the present invention relates to a display apparatus having improved display quality, reduced manufacturing cost and improved productivity.

2. Description of the Related Art

In general, a liquid crystal display (LCD) includes a LCD panel having a lower substrate, an upper substrate facing the lower substrate and a liquid crystal layer interposed between the lower and upper substrates in order to display an image; The LCD panel includes a plurality of gate lines, a plurality of data lines and a plurality of pixels connected to the gate lines and the data lines.

The LCD includes a gate driving circuit that sequentially outputs a gate pulse to the gate lines and a data driving circuit that outputs a pixel voltage to the data lines. In general, the gate driving circuit and the data driving circuit are mounted on a film or the LCD panel in a chip form.

Recently, in order to decrease the number of chips, a gate-IC-less (GIL) structure in which the gate driving circuit is directly formed on the lower substrate through a thin film process has been adopted. The gate driving circuit of the GIL-type LCD includes a shift register in which plural stages are connected sequentially to each other.

In the GIL-type LCD that has recently been developed, the structure decreases the number of data lines in order to decrease the number of data driving chips by up to one-third. In the structure that so decreases the number of data lines, three pixels are sequentially arranged along a direction in which a data line extends and are included in one pixel group that displays information for one color. Each of the three pixels has a horizontal pixel structure that extends along the direction in which the gate lines extend. In such a structure, red, green and blue color pixels of a color filter are sequentially arranged along the direction in which the data lines extend, and are arranged in a stripe-shape along the direction in which the gate lines extend.

However, when the pixels are independently operated to display a character in the above-described horizontal pixel structure, an inclined line of the character is not clearly displayed. As a result, in an LCD adopting the horizontal pixel structure, the characters are not clearly displayed.

### SUMMARY OF THE INVENTION

The present invention provides a display apparatus having improved display quality, reduced manufacturing cost and improved productivity.

In one aspect of the present invention, a display apparatus includes a display panel, a gate driver and a data driver. The display panel receives a data signal in response to a gate signal to display images corresponding to the data signal. The gate driver provides the gate signal to the display panel. The data driver provides the data signal to the display panel.

The display panel includes a plurality of gate lines, a plurality of data lines and a plurality of pixel groups. The gate lines are extended in a first direction and arranged in a second direction that is substantially perpendicular to the first direction to sequentially receive the gate signals. The data lines are extended in the second direction and arranged in the first direction to receive the data signals.

Each of the pixel groups includes first, second and third vertical pixels that are extended in the second direction and sequentially arranged in the first direction. The first to third vertical pixels are electrically connected to three consecutive gate lines among the gate lines to receive the gate signals and connected to two or fewer data lines among the data lines to receive the data signals.

According to the above, each of the pixel groups are arranged in a direction to which the gate lines are extended and includes three vertical pixels extended in a direction in which the data lines are extended. As a result, an inclined line of a character is more clearly displayed when the display apparatus adopts a clear-type font method, and the number of data driving chips may be decreased to one-third, thereby reducing the manufacturing cost and improving the productivity of the display apparatus.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view showing an exemplary embodiment of a LCD according to the present invention;

FIG. 2 is a plan view showing a layout of four pixel groups sampled from pixel groups of FIG. 1;

FIG. 3 is a waveform diagram showing input waveforms of first to third gate lines and input waveforms of first to third pixel electrodes of FIG. 2;

FIG. 4A is a view showing a character displayed in a conventional LCD panel having a horizontal pixel structure;

FIG. 4B is a view showing a character displayed in a LCD panel having a vertical pixel structure according to an embodiment of the present invention;

FIG. 5 is a plan view showing another exemplary embodiment of pixel groups according to the present invention; and

FIG. 6 is a plan view showing another exemplary embodiment of pixel groups according to the present invention.

### DESCRIPTION OF THE EMBODIMENTS

Hereinafter, the present invention is explained in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

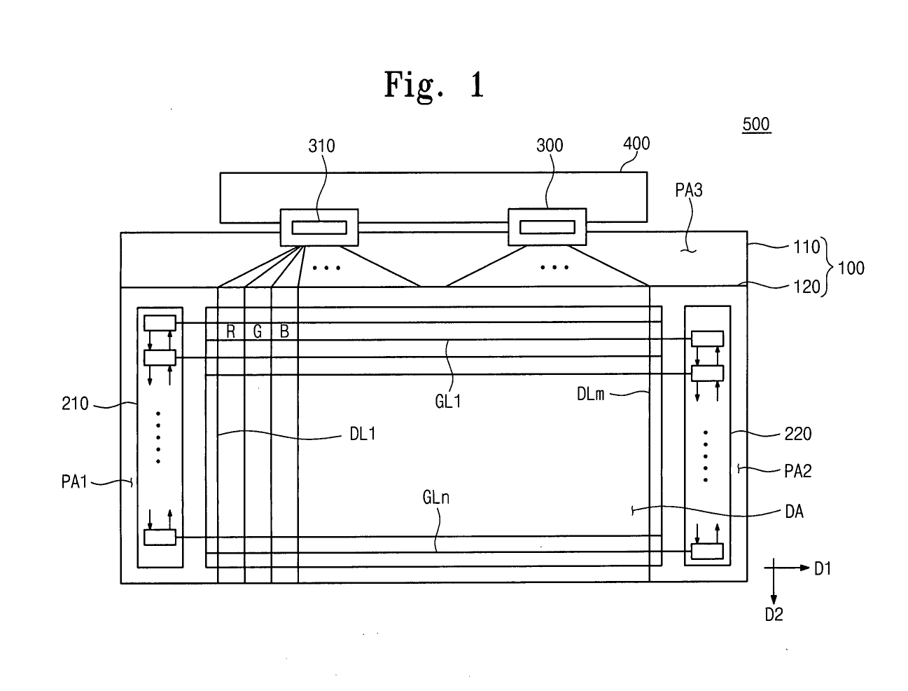

FIG. 1 is a plan view showing an exemplary embodiment of a LCD according to the present invention.

Referring to FIG. 1, a LCD 500 includes a LCD panel 100 displaying images, a printed circuit board 400 arranged adjacent to the LCD panel 100 and a tape carrier package (TCP) 300 electrically connecting the LCD panel 100 and the printed circuit board 400.

The LCD panel 100 includes an array substrate 110, an opposite substrate 120 facing the array substrate 110 and a liquid crystal layer(not shown) interposed between the array substrate 110 and the opposite substrate 120. The array substrate 110 is divided into a display area DA on which the images are displayed, a first peripheral area PA1, a second peripheral area PA2 and a third peripheral area PA3 which are adjacent to the display area DA.

In the display area DA of the array substrate 110, a plurality of pixels is arranged in a matrix configuration. Particularly, the display area DA is divided into a plurality of pixel areas by a plurality of gate lines GL1˜GLn extending in a first direction D1 and a plurality of data lines DL1˜DLm extending in a second direction D2 that is substantially perpendicular to the first direction D1. The pixels are arranged in the pixel areas.

The opposite substrate 120 includes color pixels (e.g. red R, green G, blue B color pixels) corresponding to the pixel areas in a one-to-one correspondence relationship. As shown in FIG. 1, the red R, green G and blue B color pixels are alternately arranged along the first direction D1. Three pixels that are consecutively arranged and correspond to the red R, green G and blue B color pixels, respectively, are defined as one pixel group displaying one color.

The first peripheral area PA1 is arranged adjacent to first ends of the gate lines GL1˜GLn, and a first gate driving circuit 210 is arranged in the first peripheral area PA1 to sequentially output N/2 first gate signals. The first gate driving circuit 210 includes a first shift register of which N/2 stages are connected sequentially to each other.

Output terminals of the N/2 stages are electrically connected to first ends of odd-numbered gate lines among the gate lines GL1˜GLn. Thus, the N/2 stages are sequentially turned on to sequentially apply the first gate signals to the odd-numbered gate lines. Although not shown in FIG. 1, the first shift register may further include a dummy stage that controls an operation of the (N/2)th stage.

The second peripheral area PA2 is arranged adjacent to second ends of the gate lines GL1˜GLn, and a second gate driving circuit 220 is arranged in the second peripheral area PA2 to sequentially provide N/2 second gate signals. The second gate driving circuit 220 includes a second shift register of which N/2 stages are connected sequentially to each other.

Output terminals of the N/2 stages are electrically connected to second ends of even-numbered gate lines among the gate lines GL1˜GLn. Thus, the N/2 stages are sequentially turned on to provide the second gate signals to the even-numbered gate lines. Although not shown in FIG. 1, the second shift register may further include a dummy stage that controls an operation of the (N/2)th stage.

In the present exemplary embodiment, the first gate driving circuit 210 and the second driving circuit 220 are substantially simultaneously formed onto the array substrate 110 with the pixels through a thin film process applied to form the pixels. Accordingly, the first gate driving circuit 210 and the second gate driving circuit 220 are integrated onto the array substrate 110 in a GIL structure, so that driving chips in which the first gate driving circuit 210 and the second gate driving circuit 220 are installed may be removed from the LCD 500. As a result, the productivity of the LCD 500 may be improved, the manufacturing costs are reduced and the overall size of the LCD 500 is reduced.

The third peripheral area PA3 is arranged adjacent to one end of the data lines DL1˜DLm, and a first end of the TCP 300 is attached to the third peripheral area PA3. The second end of the TCP 300 is attached to the printed circuit board 400. A data driving chip 310 is mounted on the TCP 300 to provide a pixel voltage to the data lines DL1˜DLm. Thus, the data driving chip 310 provides a data voltage to the data lies DL1˜DLm in response to a data control signal from the printed circuit board 400.

Also, a first gate control signal and a second gate control signal output from the printed circuit board 400 are provided to the first gate driving circuit 210 and the second gate driving circuit 220 through the TCP 300, respectively. Thus, the first gate driving circuit 210 sequentially provides the first gate signals to the odd-numbered gate lines in response to the first gate control signal, and the second gate driving circuit 220 sequentially provides the second gate signals to the even-numbered gate lines in response to the second gate control signal.

The pixels arranged on the array substrate 110 have a vertical pixel structure in which the length in the first direction D1 is shorter than the length in the second direction D2. Particularly, three consecutive pixels having the vertical pixel structure are defined as one pixel group, and each of the three pixels is sequentially driven for an H/3 period during a 1H period in which pixels connected to one row line are turned on in response to the first gate signal, the second gate signal and the third gate signal. Consequently, different gate signals are sequentially applied to the three pixels for the H/3 period within the 1 H period.

In the above-described structure, three gate lines and two or fewer data lines are required to turn on the three pixels in one pixel group. Thus, the number of data lines decreases by up to one third.

When the number of data lines decreases then the number of data driving chips 310 outputting the data signals also decreases. Also, the number of chips in the LCD 500 does not increase since the first gate driving circuit 210 and the second gate driving circuit 220 are directly integrated onto the array substrate 100 through the thin film process. As a result, the total number of chips in the LCD 500 decreases, thereby reducing the manufacturing cost and improving the productivity of the LCD 500.

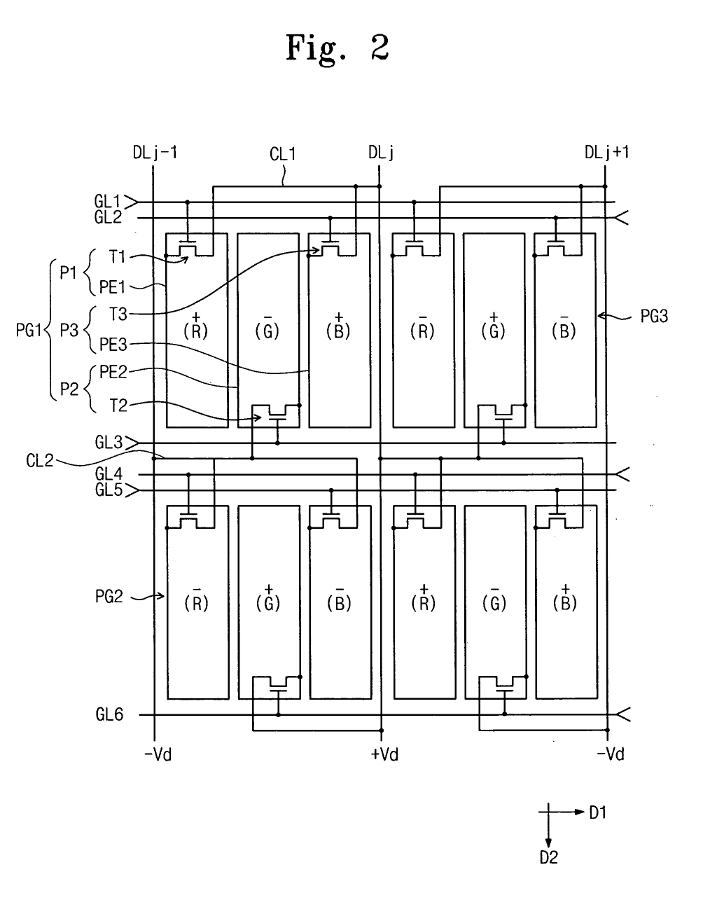

FIG. 2 is a plan view showing a layout of four pixel groups sampled from the pixel groups of FIG. 1.

Referring to FIG. 2, first, second, third, fourth, fifth and sixth gate lines GL1, GL2, GL3, GL4, GL5 and GL6 are sequentially arranged in the second direction D2, and a first pixel group PG1 is arranged between the second gate line GL2 and the third gate line GL3.

Odd-numbered gate lines GL1, GL3 and GL5 among the first to sixth gate lines GL1˜GL6 sequentially receive the first gate signal from the first gate driving circuit 210 (shown in FIG. 1), and even-numbered gate lines GL2, GL4 and GL6 among the first to sixth gate lines GL1˜GL6 sequentially receive the second gate signal from the second gate driving circuit 220 shown in FIG. 1.

The first pixel group PG1 includes a first vertical pixel P1, a second vertical pixel P2 and a third vertical pixel P3 that are consecutively arranged in the first direction D1 and extend in the second direction D2. The first vertical pixel P1, the second vertical pixel P2 and the third vertical pixel P3 correspond to a red color pixel R, a green color pixel G and blue color pixel B in a one-to-one relationship.

On the left side of the first vertical pixel P1, a (j−1)th data line DLj−1 is arranged, and a j-th data line DLj is arranged in the right side of the third vertical pixel P3.

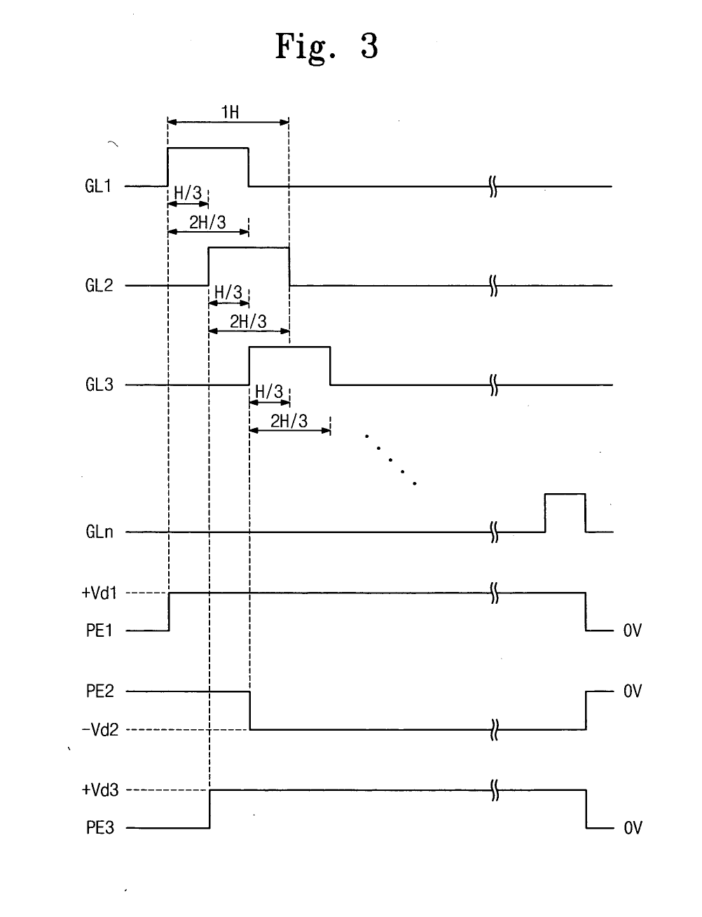

The first vertical pixel P1 is electrically connected to the first gate line GL1 and the j-th data line DLj. Particularly, the first vertical pixel P1 includes a first thin film transistor T1 and a first pixel electrode PE1. The first thin film transistor T1 includes a gate electrode electrically connected to the first gate line GL1 to receive the first gate signal from the first gate driving circuit 210 as shown in FIG. 1, a source electrode electrically connected to the j-th data line DLj through a first connection line CL1 to receive a first data signal +Vd1 having a positive polarity and a drain electrode electrically connected to the first pixel electrode PE1. Thus, when the first gate signal is applied to the first gate line GL1, the first thin film transistor T1 is turned on in response to the first gate signal, and the first data signal +Vd1 as shown in FIG. 3 having the positive polarity is output to the first pixel electrode PE1.

The second vertical pixel P2 is electrically connected to the third gate line GL3 and the (j−1)th data line DLj−1. Particularly, the second vertical pixel P2 includes a second thin film transistor T2 and a second pixel electrode PE2. The second thin film transistor T2 includes a gate electrode electrically connected to the third gate line GL3 to receive the third gate signal from the first gate driving circuit 210 as shown in FIG. 1, a source electrode electrically connected to the (j−1)th data line DLj−1 through a second connection line CL2 to receive a second data signal −Vd2 as shown in FIG. 3 having a negative polarity and a drain electrode electrically connected to the second pixel electrode PE2. Thus, when the third gate signal is applied to the third gate line GL3, the second thin film transistor T2 is turned on in response to the third gate signal, and the second data signal −Vd2 as shown in FIG. 3 having the negative polarity is output to the second pixel electrode PE2.

The third vertical pixel P3 is electrically connected to the second gate line GL2 and the j-th data line DLj. Particularly, the third vertical pixel P3 includes a third thin film transistor T3 and a third pixel electrode PE3. The third thin film transistor T3 includes a gate electrode electrically connected to the second gate line GL2 to receive the second gate signal from the second gate driving circuit 220 as shown in FIG. 1, a source electrode electrically connected to the j-th data line DLj through the first connection line CL1 to receive a third data signal +Vd3 as shown in FIG. 3 having a positive polarity and a drain electrode electrically connected to the third pixel electrode PE3. Thus, when the second gate signal is applied to the second gate line GL2, the third thin film transistor T3 is turned on in response to the second gate signal, and the third data signal +Vd3 as shown in FIG. 3 having the positive polarity is output to the third pixel electrode PE3.

In the present exemplary embodiment, the first and second gate lines GL1 and GL2 are arranged adjacent to upper ends of the first, second and third vertical pixels P1, P2 and P3, and the third gate line GL3 is arranged adjacent to lower ends of the first, second and third vertical pixels P1, P2 and P3. Thus, the first thin film transistor T1 and the third thin film transistor T3 are arranged in the upper ends of the first vertical pixel P1 and the third vertical pixel P3, respectively, and the second thin film transistor T2 is arranged in the lower end of the second vertical pixel P2.

Also, the third gate line GL3, the fourth gate line GL4 and the fifth gate line GL5 are arranged between the first pixel group PG1 and the second pixel group PG2 that is arranged adjacent to the first pixel group PG1 in the second direction D2. As a result, three gate lines are arranged between two pixel groups that are arranged adjacent to each other in the second direction D2 in the LCD panel 100 shown in FIG. 1.

The j-th data line DLj is arranged between the first pixel group PG1 and a third pixel group PG3 that is arranged adjacent to the first pixel group PG1 in the first direction D1. As a result, one data line is arranged between two pixel groups that are arranged adjacent to each other in the first direction D1.

In the present exemplary embodiment, data signals having different polarities are applied to the (j−1)th data line DLj−1 and the j-th data line DLj, respectively. In order to drive the LCD panel 100 as shown in FIG. 1, in a 1×1 dot inversion method, the j-th data line DLj is connected to the first vertical pixel P1 and the third vertical pixel P3 of the first pixel group PG1, and the (j−1)th data line DLj−1 is connected to the second vertical pixel P2 of the first pixel group PG1, and first and third vertical pixels P1 and P3 of the second pixel group PG2. Thus, data signals having different polarities are applied to vertical pixels arranged in the first direction D1 and adjacent to each other in the second direction D2, so that the LCD panel 100 as shown in FIG. 1 may be driven in a 1×1 dot inversion method.

FIG. 3 is a waveform diagram showing input waveforms of the first to third gate lines and input waveforms of the first to third pixel electrodes shown in FIG. 2.

Referring to FIGS. 1, 2 and 3, the first gate line GL1 receives the first gate signal at the high level from the first gate driving circuit 210 shown in FIG. 1, during a first 2H/3 period. The second gate line GL2 receives the second gate signal at the high level from the second gate driving circuit 220 shown in FIG. 1, during a second 2H/3 period after a H/3 period from the time at which the first gate line GL1 is generated at the high level. Then, the third gate line GL3 receives the third gate signal at the high level from the first gate driving circuit 210 as shown in FIG. 1 during a third 2H/3 period after a H/3 period from the time at which the second gate line GL2 is generated at the high level.

During an earlier H/3 period within the first 2H/3 period, the first pixel electrode PE1 of the first vertical pixel P1 receives the first data signal +Vd1 as shown in FIG. 3 having the positive polarity from the j-th data line DLj. Then, during an earlier H/3 period within the second 2H/3 period, the third pixel electrode PE3 of the third vertical pixel P3 receives the second data signal +Vd2 as shown in FIG. 3 having the positive polarity from the j-th data line DLj. Then, during an earlier H/3 period within the third 2H/3 period, the second pixel electrode PE2 of the second vertical pixel P2 receives the second data signal −Vd2 as shown in FIG. 3 having the negative polarity from the (j−1)th data line DLj−1.

That is, as shown in FIGS. 1, 2 and 3, the first gate line GL1 and the second gate line GL2 are connected to the first vertical pixel P1 and the third vertical pixel P3, respectively, and the third gate line GL3 is connected to the second vertical pixel P2. Thus, in the first pixel group PG1, the first to third vertical pixels P1, P2 and P3 are operated in order of the first vertical pixel P1, the third vertical pixel P3 and the second vertical pixel P2.

When a period during which pixels connected to one row line are operated is defined as a 1H period, the first to third vertical pixels P1, P2 and P3 receive the first to third data signals +Vd1, −Vd2 and +Vd3, respectively, each during the H/3 periods within the 1H period. Thus, the first pixel group PG1 including the first to third vertical pixels P1, P2 and P3 displays a gray-scale and a color corresponding to the first to third data signals +Vd1, −Vd2 and +Vd3. The first to third data signals +Vd1, −Vd2 and +Vd3 applied to the first to third vertical pixels P1, P2 and P3 are maintained during one frame by a liquid crystal capacitor that is defined by a pixel electrode, a liquid crystal layer and a common electrode, so that the gray-scale and color may be displayed during one frame.

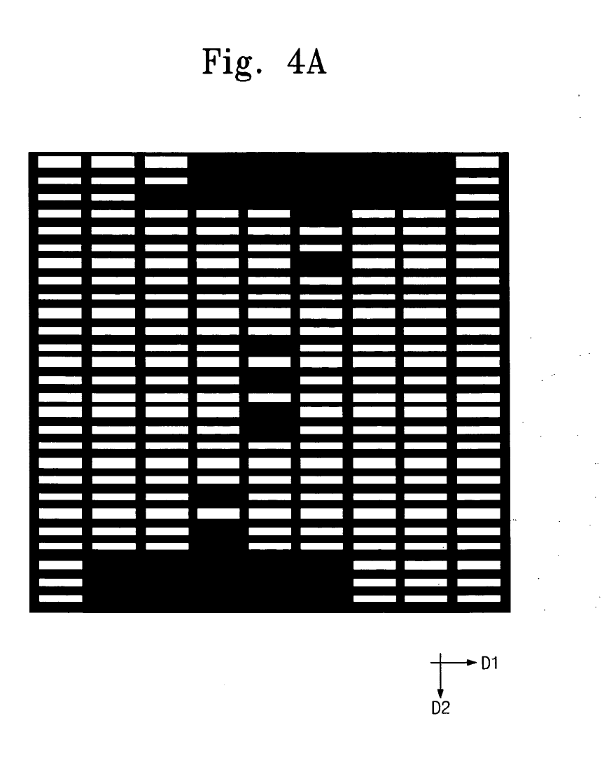

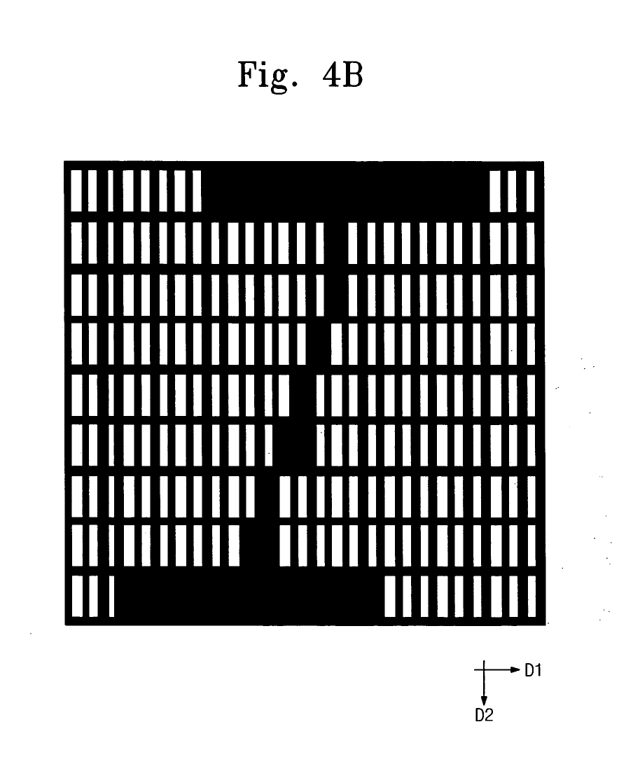

FIG. 4A is a view showing a character displayed in a conventional LCD panel having a horizontal pixel structure, and FIG. 4B is a view showing the same character displayed in a LCD panel having a vertical pixel structure according to the present invention.

Referring to FIG. 4A, in a conventional GIL-type LCD panel having a horizontal pixel structure, pixels are operated in a clear-type font method when displaying characters in order to decrease the number of data lines. Particularly, in the clear-type font method, each of the three pixels included in one pixel group is individually operated, and the character is displayed not by a pixel group but by a pixel.

In the conventional horizontal pixel structure, however, one pixel group includes three consecutive horizontal pixels sequentially arranged in the second direction D2. Thus, although the three horizontal pixels are individually operated through the clear-type font method, an inclined line of a character cannot be clearly displayed.

Referring to FIG. 4B, the GIL-type LCD panel according to one embodiment of the present invention has a vertical pixel structure and is designed to decrease the total number of data lines, so that the GIL-type LCD panel according to one embodiment of the present invention has advantages over the conventional GIL-type LCD panel. Also, in the GIL-type LCD panel according to one embodiment of the present invention, one pixel group includes three vertical pixels sequentially arranged in the first direction D1. Therefore, as shown in FIG. 4B, when the GIL-type LCD panel adopts the clear-type font method, the inclined line of the character is more clearly displayed.

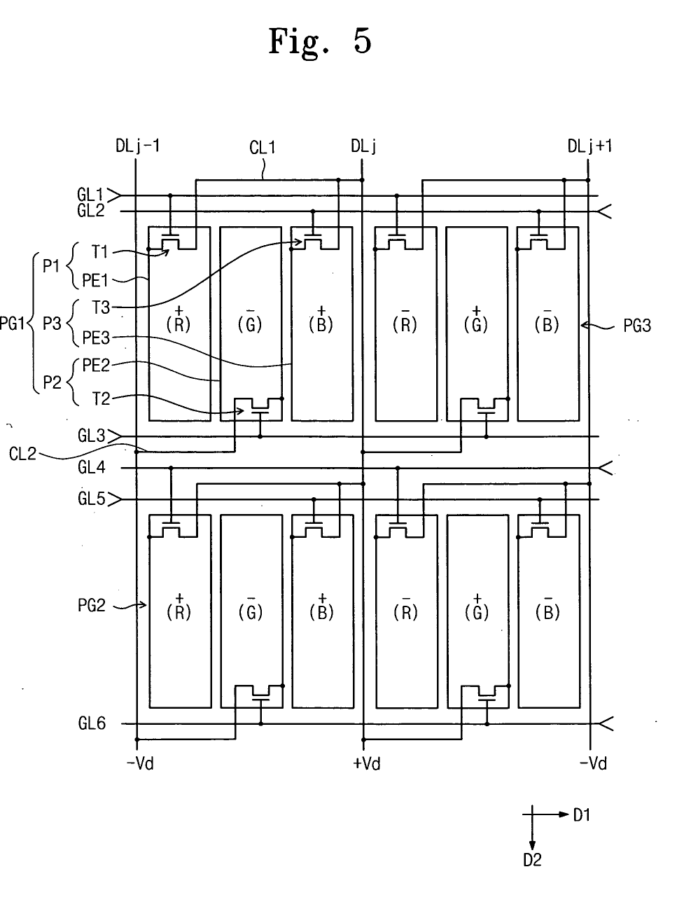

FIG. 5 is a plan view showing a second embodiment of the present invention. In FIG. 5, the same reference numerals denote the same elements in FIG. 2, and thus the detailed descriptions of the same elements are omitted.

Referring to FIG. 5, a GIL-type LCD panel according to a second embodiment of the present invention is driven in a 2×1 dot inversion method. That is, the polarity of a data signal applied to a pixel electrode is inverted every two rows and every pixel.

In FIG. 5, a first pixel group PG1 and a second pixel group PG2 that is arranged adjacent to the first pixel group PG1 in a second direction D2 have the same connection structure with each other. More specifically, a first vertical pixel P1 and a third vertical pixel P3 of the first pixel group PG1 are connected to a j-th data line DLj and a second vertical pixel P2 of the first pixel group PG1 is connected to (j−1)th data line DLj−1. Likewise, a first vertical pixel P1 and a third vertical pixel P3 of the second pixel group PG2 are connected to the j-th data line DLj and a third vertical pixel P3 of the second pixel group PG2 is connected to the (j−1)th data line DLj−1.

Thus, a data signal +Vd having a positive polarity is applied to the first and third vertical pixels P1 and P3 of the first pixel group PG1 and to the first and third vertical pixels P1 and P3 of the second pixel group PG2, and a data signal −Vd having a negative polarity is applied to the second vertical pixel P2 of the first pixel group PG1 and the second vertical pixel P2 of the second pixel group PG2. Therefore, the GIL-type LCD panel may be driven in a 2×1 dot inversion method.

Although not shown in FIG. 5, when the pixel groups arranged adjacent in the second direction D2 have the same structure, a display apparatus may be driven in a column inversion method.

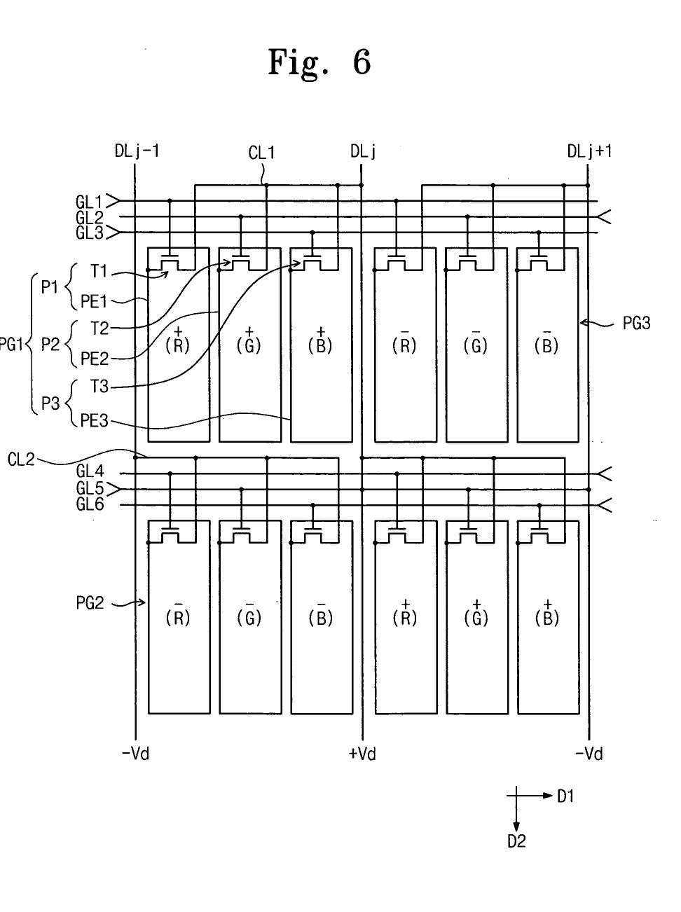

FIG. 6 is a plan view showing a third embodiment of the present invention. In FIG. 6, the same reference numerals denote the same elements in FIG. 2, and thus the detailed descriptions of the same elements are omitted.

Referring to FIG. 6, a GIL-type LCD panel according to the third exemplary embodiment of the present invention is driven in a 1×3 dot inversion method. That is, a polarity of a data signal applied to a pixel electrode is inverted every one row and every three pixels.

Particularly, a first vertical pixel P1, a second vertical pixel P2 and a third vertical pixel P3 of a first pixel group PG1 are connected to a j-th data line DLj. In a second pixel group PG2 arranged adjacent to the first pixel group PG1 in a second direction D2, a first vertical pixel P1, a second vertical pixel P2 and a third vertical pixel P3 of the second pixel group PG2 are connected to a (j−1)th data line DLj−1. In a third pixel group PG3 arranged adjacent to the first pixel group PG1 in a first direction D1, a first vertical pixel P1, a second vertical pixel P2 and a third vertical pixel P3 of the third pixel group PG3 are connected to a (j−1)th data line DLj+1. In the present exemplary embodiment, a data signal −Vd having a negative polarity is applied to the (j−1)th data line DLj−1 and the (j−1)th data line DLj+1, and a data signal +Vd having a positive polarity is applied to the j-th data line DLj.

Thus, the data signal +Vd having the positive polarity is applied to the first to third vertical pixels P1, P2 and P3 of the first pixel group PG1, the data signal −Vd having the negative polarity is applied to the first to third vertical pixels P1, P2 and P3 of the second pixel group PG2, and the data signal −Vd having the negative polarity is applied to the first to third vertical pixels P1, P2 and P3 of the third pixel group PG3. As a result, the GIL-type LCD panel may be driven in a 1×3 dot inversion method.

As described above, since the first to third vertical pixels P1, P2 and P3 of the first pixel group PG1 are sequentially turned on and commonly connected to the j-th data line DLj, a first gate line GL1, a second gate line GL2 and a third gate line GL3 are arranged adjacent to an upper end of the first pixel group PG1. Also, a fourth gate line GL4, a fifth gate line GL5 and a sixth gate line GL6 are arranged between the first pixel group PG1 and the second pixel group PG2 adjacent to the first pixel group PG1 in the second direction D2.

In FIGS. 1 to 6, pixel structures in which the GIL-type LCD panel is driven in a 1×1 dot inversion method, a 2×1 dot inversion method and a 1×3 dot inversion method have been described. Although not shown in figures, the GIL-type LCD panel may be driven by various other inversion methods.

According to the disclosed display apparatus, the pixel group displaying information of one color includes three pixels, and the three pixels are electrically connected to three gate lines and two or fewer data lines. Each of the three pixels has the vertical pixel structure extending in the direction parallel to the data lines.

Thus, the pixel groups are arranged along the direction in which the gate lines extend and each of the pixel groups includes the three vertical pixels, thereby clearly displaying the inclined line of the character when the clear-type font method is adopted by the display apparatus. Also, since the number of data driving chips is decreased to one-third, the manufacturing cost of the display apparatus is reduced and the productivity of the display apparatus is improved.

Although the exemplary embodiments of the present invention have been described, it is understood that the present invention is not limited to these exemplary embodiments, but various changes and modifications can be made by one of ordinary skill in the art within the spirit and scope of the present invention as hereinafter claimed.

What is claimed is:

1. A display apparatus comprising:
a display panel adapted to receive data signals and gate signals and being operative to display images in response thereto;
a gate driver adapted to provide the gate signals to the display panel;
a data driver adapted to provide the data signals to the display panel, the display panel comprising:
a plurality of gate lines extending in a first direction;
a plurality of data lines extending in a second direction substantially perpendicular to the first direction; and
a plurality of pixel groups, each group including a first vertical pixel, a second vertical pixel and a third vertical pixel extending in the second direction, the pixel groups being sequentially arranged in the first direction, wherein the first, second and third vertical pixels in each pixel group are respectively connected to three consecutive gate lines among the gate lines to receive the gate signals, and connected to two or fewer data lines among the data lines to receive the data signals.

2. The display apparatus of claim 1, wherein the three consecutive gate lines are arranged between two pixel groups that are arranged along the second direction.

3. The display apparatus of claim 1, wherein each of the three consecutive gate lines receives an associate gate signal during a 2H/3 period, and three gate signals so sequentially applied to the three consecutive gate lines are delayed by a H/3 period during which pixel groups connected to one row are turned on for a 1H period.

4. The display apparatus of claim 1, wherein a first gate line among the three consecutive gate lines is electrically connected to the first vertical pixel, a second gate line among the three consecutive gate lines is electrically connected to the third vertical pixel, and a third gate line among the three consecutive gate lines is electrically connected to the second vertical pixel.

5. The display apparatus of claim 4, wherein a first data line adjacent to one pixel group is electrically connected to a first vertical pixel and a third vertical pixel in the one pixel group, and a second data line adjacent to the one pixel group is electrically connected to a second vertical pixel in the one pixel group.

6. The display apparatus of claim 4, wherein the first gate line and the second gate line are arranged adjacent to first ends of the first to third vertical pixels, and the third gate line is arranged adjacent to second ends of the first to third vertical pixels.

7. The display apparatus of claim 6, further comprising:
a first connection line arranged adjacent to the first ends of the first to third vertical pixels, the first connection line electrically connecting the first data line to the first and third vertical pixels; and
a second connection line arranged adjacent to the second ends of the first to third vertical pixels to electrically connecting the second data line to the second vertical pixel.

8. The display apparatus of claim 7, wherein the first connection line electrically connects the first data line to a second vertical pixel of a previous pixel group, and the second connection line electrically connects the second data line to a first vertical pixel and a third vertical pixel of a next pixel group.

9. The display apparatus of claim 5, wherein the first data line receives a first data signal having a first polarity, and the second data line receives a second data signal having a second polarity different from the first polarity.

10. The display apparatus of claim 9, wherein the display panel is operated in a 1×1 dot inversion method.

11. The display apparatus of claim 9, wherein the display panel is operated in a 2×1 dot inversion method.

12. The display apparatus of claim 1, wherein a first gate line among the three consecutive gate lines is electrically connected to the first vertical pixel, a second gate line among the three consecutive gate lines is electrically connected to the second vertical pixel, a third gate line among the three consecutive gate lines is electrically connected to the third vertical pixel, and the first, second and third vertical pixels are commonly connected to one data line.

13. The display apparatus of claim 12, wherein the display panel is operated in a 1×3 dot inversion method.

14. The display apparatus of claim 1, wherein each of the first, second and third vertical pixels comprises:
a thin film transistor connected to an associated gate line; and
a pixel electrode connected to a thin film transistor.

15. The display apparatus of claim 14, wherein the display panel further comprises red, green and blue color pixels associated respectively with the first, second and third vertical pixels.

16. The display apparatus of claim 1, wherein the gate driver is directly formed on the display panel.

17. The display apparatus of claim 1, wherein the gate driver further comprises:
a first gate driver electrically connected to first ends of odd-numbered gate lines among the gate lines to output a first gate signal among the gate signals; and
a second gate driver electrically connected to second ends of even-numbered gate lines among the gate lines to output a second gate signal among the gate signals.

18. The display apparatus of claim 1, wherein the data driver comprises a plurality of chips.
